(19) United States
(12) Patent Application Publication
(10) Pub. No.: US 2024/0155690 A1
(43) Pub. Date: May 9, 2024

(54) METHOD AND APPARATUS FOR CONTROLLING RANDOM ACCESS, AND TERMINAL DEVICE

(71) Applicant: GUANGDONG OPPO MOBILE TELECOMMUNICATIONS CORP., LTD., Dongguan (CN)

(72) Inventor: Shukun WANG, Dongguan (CN)

(73) Assignee: GUANGDONG OPPO MOBILE TELECOMMUNICATIONS CORP., LTD., Dongguan (CN)

(21) Appl. No.: 18/408,365

(22) Filed: Jan. 9, 2024

Related U.S. Application Data
(63) Continuation of application No. PCT/CN2021/117780, filed on Sep. 10, 2021.

(51) Int. Cl. H04W 74/0833; H04W 24/04; H04W 74/00

(52) U.S. Cl. CPC H04W 74/0833; H04W 24/04; H04W 74/006

(57) ABSTRACT

Embodiments of the present application provide a method and apparatus for controlling random access, and a terminal device, the method including: a terminal device receives a first command, the first command being used to activate an SCG; and the terminal device determines, on the basis of a first timer, whether to initiate a random access procedure to the SCG and/or determines, on the basis of a second timer, whether the random access procedure initiated to the SCG is successful.

### CROSS-REFERENCE TO RELATED APPLICATION

This application is a continuation application of International Patent Application No. PCT/CN2021/117780 filed on Sep. 10, 2021. The entire content of the prior application is incorporated by reference herein in its entirety.

### BACKGROUND

In order to support power saving of a UE and rapidly establish a Secondary Cell Group (SCG), the standard agrees to support a concept of deactivation of the SCG. In other words, a state of the SCG may be switched from an active state to a deactivated state.

After the SCG is in the deactivated state, when the UE receives an SCG activation command, it is not clear how to implement the random access procedure for the SCG.

### SUMMARY

The disclosure relate to the technical field of mobile communication, and more particularly, to a method for controlling random access, and a User Equipment (UE).

Embodiments of the present disclosure provide a method and an apparatus for controlling random access, a UE, a chip, a computer-readable storage medium, a computer program product and a computer program.

The method for controlling the random access provided by an embodiment of the present disclosure includes the following operations.

A UE receives a first command, and the first command is used for activating a SCG.

The UE determines whether to initiate a random access procedure to the SCG based on a first timer and/or whether the random access procedure initiated to the SCG is successful based on a second timer.

The apparatus for controlling the random access provided by an embodiment of the present disclosure is applied to a UE, and the apparatus includes a receiving unit and a determination unit.

The receiving unit is configured to receive a first command, and the first command is used for activating a SCG.

The determination unit is configured to determine whether to initiate a random access procedure to the SCG based on a first timer and/or whether the random access procedure initiated to the SCG is successful based on a second timer.

The UE provided by an embodiment of the present disclosure includes a processor and a memory. The memory is configured to store a computer program, and the processor is configured to invoke and run the computer program stored in the memory to cause the UE to execute the above method for controlling the random access.

The chip provided by an embodiment of the present disclosure is configured to implement the above method for controlling the random access.

Specifically, the chip includes a processor configured to invoke and run a computer program from a memory to cause a device installed with the chip to execute the above method for controlling random access.

The computer-readable storage medium provided by an embodiment of the present disclosure is configured to store a computer program. The computer program causes a computer to execute the above method for controlling the random access.

The computer program product provided by an embodiment of the present disclosure includes computer program instructions. The computer program instructions cause a computer to execute the above method for controlling the random access.

The computer program provided by an embodiment of the present disclosure causes a computer to execute the above method for controlling random access when executed on the computer.

### BRIEF DESCRIPTION OF THE DRAWINGS

The accompanying drawings illustrated herein are used to provide a further understanding of the present disclosure and form a part of the present disclosure. The illustrative embodiments of the present disclosure and the description thereof are used to explain the present disclosure and do not constitute undue limitations on the present disclosure. In the accompanying drawings:

FIG. 1 is a diagram of an application scenario according to an embodiment of the present disclosure.

FIG. 2 is a diagram of a bearer type according to an embodiment of the present disclosure.

FIG. 3 is a flowchart of a method for controlling random access according to an embodiment of the present disclosure.

FIG. 4 is a structure diagram of an apparatus for controlling random access according to an embodiment of the present disclosure.

FIG. 5 is a structure diagram of a communication device according to an embodiment of the present disclosure.

FIG. 6 is a structure diagram of a chip according to an embodiment of the present disclosure.

FIG. 7 is a block diagram of a communication system according to an embodiment of the present disclosure.

### DETAILED DESCRIPTION

The technical solution in the embodiments of the present disclosure would be described below in conjunction with the accompanying drawings in the embodiments of the present disclosure. It is apparent that the described embodiments are a part of the embodiments of the present disclosure, rather than all of the embodiments. Based on the embodiments of the present disclosure, all other embodiments obtained by those of ordinary skill in the art without creative effort fall within the scope of protection of the present disclosure.

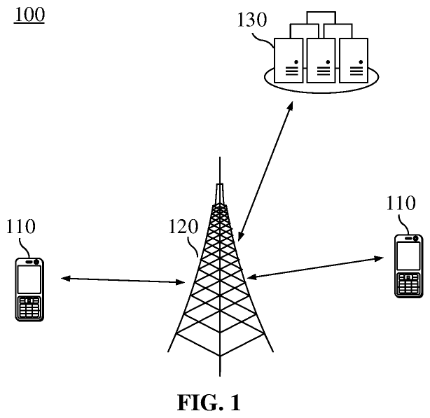

FIG. 1 is a diagram of an application scenario according to an embodiment of the present disclosure.

As illustrated in FIG. 1, the communication system 100 may include a terminal 110 and a network device 120. The network device 120 may communicate with the terminal 110 through an air interface. Multi-service transmissions are supported between the terminal 110 and the network device 120.

It should be understood that the embodiments of the present disclosure are described only using communication system 100 as an example, and the embodiments of the present disclosure are not limited thereto. That is, the technical solution in the embodiments of the present disclosure can be applied to various communication systems, such as a Long Term Evolution (LTE) system, an LTE Time Division Duplex (TDD), a Universal Mobile Telecommunications System (UMTS), an Internet of Things (IoT) system, a Narrow Band Internet of Things (NB-IoT) system, an enhanced Machine-Type Communications (eMTC) system, a 5G communication system (also being referred to as a new radio (NR) communication system), or a future communication system, etc.

In the communication system 100 illustrated in FIG. 1, the network device 120 may be an access network device that communicates with the terminal 110. The access network device may provide communication coverage for a particular geographic area and may communicate with a terminal 110 (e.g., a UE) located within the coverage area.

The network device 120 may be an evolutional node B (eNB or eNodeB) in the LTE system, a Next Generation Radio Access Network (NG RAN) device, a base station (gNB) in the NR system, or a wireless controller in a Cloud Radio Access Network (CRAN). Alternatively, the network device 120 may also be a relay station, an access point, a vehicle-mounted equipment, a wearable device, a concentrator, a switch, a bridge, a router, or a network device in a future evolved Public Land Mobile Network (PLMN), etc.

The terminal 110 may be any UE, which includes but is not limited to a terminal device in wired or wireless connection with the network device 120 or other terminal devices.

For example, the terminal 110 may refer to an access terminal, a User Equipment (UE), a user unit, a user station, a mobile station, a mobile platform, a remote station, a remote terminal, a mobile device, a user terminal, a terminal, a wireless communication device, a user agent or a user apparatus. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device having a wireless communication function, a computing device or other processing device connected to a wireless modem, a vehicle-mounted equipment, a wearable device, a UE in a 5G network or a UE in a future evolution network, etc.

The terminal 110 may be used for a device to device (D2D) communication.

The wireless communication system 100 may further include a core network device 130 that communicates with the base station. The core network device 130 may be a 5G core (5GC) device such as an Access and Mobility Management Function (AMF), an Authentication Server Function (AUSF), a User Plane Function (UPF), or a Session Management Function (SMF). Alternatively, the core network device 130 may also be an Evolved Packet Core (EPC) device in the LTE network, for example, a Session Management Function+Core Packet Gateway (SMF+PGW-C) device. It should be understood that the SMF+PGW-C can simultaneously achieve functions that can be achieved by the SMF and the PGW-C. In the process of the network evolution, the core network device may also be referred to as other names, or may be a new network entity formed by dividing the functions of the core network, which would not be limited in the embodiments of the present disclosure.

Communication between various functional units in the communication system 100 may also be achieved by establishing a connection through a Next Generation (NG) interface.

For example, the terminal device establishes air interface connection with the access network device through an NR interface for transmission of user plane data and control plane signaling. The terminal device may establish a control plane signaling connection with the AMF through an NG interface 1 (N1 for short). The access network device, such as a next generation radio access base station (gNB), may establish a user plane data connection with the UPF through an NG interface 3 (N3 for short). The access network device may establish a control plane signaling connection with the AMF through an NG interface 2 (N2 for short). The UPF may establish a control plane signaling connection with the SMF through an NG interface 4 (N4 for short). The UPF may interact user plane data with a data network through an NG interface 6 (N6 for short). The AMF may establish a control plane signaling connection with the SMF through an NG interface 11 (N11 for short). The SMF may establish a control plane signaling connection with the PCF through an NG interface 7 (N7 for short).

FIG. 1 exemplarily illustrates a base station, a core network device and two terminal devices. Optionally, the wireless communication system 100 may include multiple base station devices, and a respective number of terminal devices may be included within the coverage area of each of the base station devices, which would not be limited in embodiments of the present disclosure.

It should be noted that FIG. 1 only illustrates, by way of an example, the system to which the present disclosure is applied. Of course the method illustrated in the embodiments of the present disclosure may also be applied to other systems. In addition, the terms “system” and “network” in the present disclosure may usually be used interchangeably. In the disclosure, term “and/or” refers to only an association relationship for describing associated objects and represents that three relationships may exist. For example, A and/or B may represent three cases: i.e., only A exists, both A and B exist, and only B exists. Furthermore, character “/” in the disclosure usually represents that previous and next associated objects form an “or” relationship. It should also be understood that the term “indication” mentioned in the embodiments of the disclosure may be a direct indication, or may be an indirect indication, or may be represented as having an association relationship. For example, A indicates B, which may indicate that A directly indicates B, for example, B may be obtained by A; or may indicate that A indirectly indicates B, for example, A indicates C, and B may be obtained by C; or may indicate that A and B have an association relationship there-between. It should also be understood that the term “corresponding” mentioned in the embodiments of the present disclosure may indicate that there are direct or indirect correspondences between two objects, or may indicate that the two objects have an association relationship there-between, or may have an indicating and indicated relationship, a configuring and configured relationship, or the like. It should also be understood that the terms “predefined” or “predefined rules” mentioned in the embodiments of the present disclosure may be implemented by pre-storing corresponding codes and tables or by other means that may be used to indicate relevant information in devices (e.g., including terminal devices and network devices), specific implementations of which are not limited herein. For example, the “pre-defined” may refer to what is defined in protocol. It should also be understood that, in the embodiments of the present disclosure, the “protocol” may refer to standard protocols in the communication field, and may include, for example, an LTE protocol, an NR protocol and related protocols applied in future communication systems, which are not limited in the present disclosure.

In order to facilitate the understanding of the technical solution of the embodiments of the present disclosure, the related technologies of the embodiments of the present disclosure are described below. The following related technologies, as optional schemes, may be arbitrarily combined with the technical solution of the embodiments of the present disclosure, all of which belong to the scope of protection of the embodiments of the present disclosure.

With a pursuit of speed, latency, high-speed mobility and energy efficiency by human beings, as well as diversity and complexity of services in the future life, the 3rd Generation Partnership Project (3GPP) international standard organization began to develop 5G. Main application scenario of 5G includes: an enhanced Mobile Broadband (eMBB), an Ultra-Reliable Low-Latency Communications (URLLC) and a massive Machine-Type Communications (mMTC).

On one hand, the eMBB still aims to provide users with access to multimedia contents, services and data, which has a rapidly growing demand. On the other hand, the eMBB may be deployed in different scenarios, such as in an indoor area, in an urban area, in a rural area, etc., and capabilities and requirements for the eMBB are quite different. Therefore, the eMBB cannot be generalized and must be analyzed in detail in combination with the specific deployment scenarios. Typical applications of the URLLC may include: industrial automation, power automation, remote medical operations (surgeries), traffic safety assurance, and the like. Typical characteristics of the mMTC may include: a high connection density, a small data volume, latency-insensitive service, and low cost and a long service life of a module.

In the early deployment of the NR, it is difficult to obtain complete NR coverage. Therefore, the typical network coverage includes wide-area LTE coverage and an island coverage mode of the NR. Moreover, a large number of LTEs are deployed below 6 GHz, and there is little spectrum below 6 GHz available for 5G. Therefore, it is necessary to study spectrum applications above 6 GHz for the NR. However, for the high-frequency band, the coverage is limited and the signals fade quickly. At the same time, in order to protect the early investment of mobile operators in LTE, a working mode of tight interworking between the LTE and the NR is proposed.

In order to realize 5G network deployments and commercial applications as soon as possible, the 3GPP completes a first 5G version before the end of December 2017, i.e., an E-UTRA-NR Dual Connectivity (EN-DC). In the EN-DC, a LTE base station (eNB) serves as a Master Node (MN) and a NR base station (gNB or en-gNB) serves as a Secondary Node (SN). The MN is mainly responsible for Radio Resource Control (RRC) control functions and is connected to control planes of a core network. The SN may be configured with an auxiliary signaling, such as a Service Radio Bearer 3 (SRB3), which mainly provides a data transmission function.

In the later stage of R15, other Dual Connectivity (DC) modes would be supported, i.e., a NR-E-UTRA Dual Connectivity (NE-DC) mode, a 5GC-EN-DC mode and a NR DC mode. For the EN-DC, a core network connected by an access network is an Evolved Packet Core network (EPC), while the core network connected by the other DC modes is a 5G Core Network (5GC).

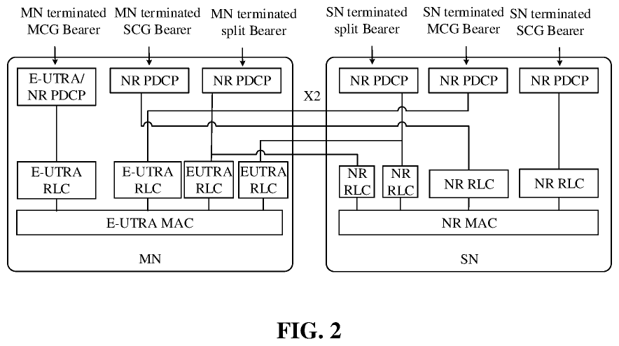

In a Multi-RAT Dual Connectivity (MR-DC), referring to FIG. 2, the bearer types are divided into an MN terminated MCG Bearer, an MN terminated SCG Bearer, an MN terminated split Bearer, an SN terminated MCG Bearer, an SN terminated SCG Bearer and an SN terminated split Bearer. The “MN terminated” means that Packet Data Convergence Protocol (PDCP) resources (i.e. PDCP entities) used by the bearer are located on a MN side, and the “SN terminated” means that the PDCP resources used by the bearer are located on a SN side. The “MCG bearer” means that RLC/MAC/PHY resources used by the bearer are located on the MN side. The “SCG bearer” means that the RLC/MAC/PHY resources used by the bearer are located on the SN side. The “split bearer” means that the RLC/MAC/PHY resources used by the bearer are located on both the MN side and the SN side.

In order to support power saving of a terminal device and quickly establish a SCG, a deactivated state is introduced into a state of the SCG. The SCG enters the deactivated state after being deactivated, and the SCG enters an active state after being activated. After the SCG is deactivated, the terminal device does not monitor a Physical Downlink Control Channel (PDCCH) on the SCG, and does not perform the transmission and reception of data.

After the SCG is in the deactivated state, in response to that the terminal device receives an SCG activation command, it is not clear how to execute the random access procedure for the SCG. In response to that the terminal device receives the SCG activation command, there is a possible situation that a Timing Advance (TA) and a Transmission Configuration Indication (TCI) state of the terminal device on the SCG side are still valid. At this time, the terminal device may omit a random access procedure to the SCG, and the terminal device may receive scheduling information on a Primary Secondary Cell (PSCell) (i.e., a PDCCH scrambled by a Cell Radio Network Temporary Identifier (C-RNTI) on the PSCell side). In response to that the terminal device receives the SCG activation command, there is another possible situation where there is a problem between the terminal device and the network side, and the TA and TCI state of the terminal device on the SCG side are invalid, resulting in the terminal device being unable receive the scheduling information on the PSCell. How to avoid the above-mentioned anomaly and make the terminal device recover from the anomaly as soon as possible is a problem that needs to be clarified.

Therefore, the following technical solutions according to embodiments of the present disclosure are proposed.

It should be noted that in the embodiments of the present disclosure, the description of the “MCG side” may also be referred to as the “MN side” and the description of the “SCG side” may also be referred to as the “SN side”.

The technical solutions of the embodiments of the present disclosure are applied to a DC architecture, a master node in the DC is an MN, and a secondary node in the DC is an SN. That is, the MN and the SN are two nodes in the DC. A cell group on the MN side is referred to as an MCG, and a cell group on the SN side is referred to as an SCG. The type of the DC is not limited in the embodiments of the present disclosure, for example, the type of the DC may be an MR-DC, an EN-DC, an NE-DC, an NR-DC, etc.

In order to facilitate the understanding of the technical solutions of the embodiments of the present disclosure, the technical solution of the present disclosure would be described in detail below with reference to specific embodiments, the above related technologies as optional solutions can be arbitrarily combined with the technical solutions of the embodiments of the present disclosure, and all of them belong to the scope of protection of the embodiments of the present disclosure. The embodiments of the present disclosure include at least some of the following.

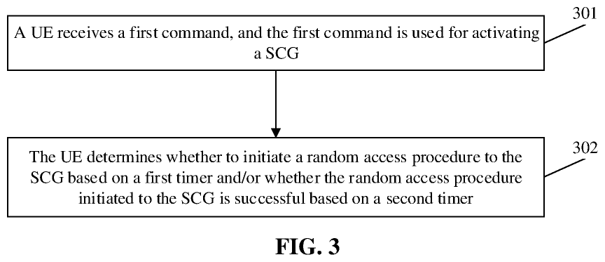

FIG. 3 is a flowchart of a method for controlling random access according to an embodiment of the present disclosure. As shown in FIG. 3, the method for controlling the random access includes the following operations.

At an operation 301, a UE receives a first command, and the first command is used for activating a SCG.

In some alternative implementations, the first command is carried in a Media Access Control (MAC) Control Element (CE).

In some alternative implementations, the first command is further used for deactivating other SCGs. As an example, the first command is used for activating an SCG1 and deactivating an SCG2.

In the embodiments of the present disclosure, the first command may also be referred to as an SCG activation command, an SCG deactivation command, or an SCG activation/deactivation command. The name of the first command is not limited in the present disclosure.

It should be noted that when the SCG is in a deactivated state, the UE receives the first command for activating the SCG.

At an operation 302, the UE determines whether to initiate a random access procedure to the SCG based on a first timer and/or whether the random access procedure initiated to the SCG is successful based on a second timer.

In the embodiments of the present disclosure, after the UE receives the first command, the UE determines whether to initiate the random access procedure to the SCG based on the first timer and/or whether the random access procedure initiated to the SCG is successful based on the second timer, which would be described as follows.

First Solution

In the embodiments of the present disclosure, after receiving the first command, the UE determines whether to initiate the random access procedure to the SCG based on the first timer.

In some alternative implementations, after receiving the first command, the UE directly starts the first timer.

In some alternative implementations, after receiving the first command, the UE starts the first timer in a case that a first condition is satisfied. Further, optionally, the first condition includes that the UE determines not to initiate the random access procedure to the SCG based on an indication from a network device, or that the UE determines not to initiate the random access procedure to the SCG based on an evaluation of the UE.

As an example, after the UE receives the first command, in response to that the UE determines not to initiate the random access procedure to the SCG according to the indication from the network device, the UE starts the first timer T1.

As an example, after the UE receives the first command, in response to that the UE determines not to initiate the random access procedure to the SCG according to the evaluation of the UE, the UE starts the first timer T1.

As an example, after the UE receives the first command, the UE directly starts the first timer T1.

In the embodiments of the present disclosure, in response to that a PDCCH configured for scheduling a PSCell is received by the UE during an operation of the first timer, the UE determines not to initiate the random access procedure to the SCG and stops the first timer. In response to that the first timer expires, the UE determines to initiate the random access procedure to the SCG and/or to send an SCGFailureInformation message to a MN.

Here, the PDCCH configured for scheduling the PSCell carries scheduling information of the PSCell. The PDCCH configured for scheduling the PSCell is a PDCCH scrambled by a C-RNTI of the SCG side.

As an example, in response to that the UE receives the PDCCH configured for scheduling the PSCell during the operation of the first timer T1, the UE stops the first timer T1. In response to that the first timer expires, the UE determines to initiate the random access procedure to the SCG and/or to send an SCGFailureInformation message to an MN.

It should be noted that in the embodiments of the present disclosure, the description of “initiating a random access procedure to an SCG” may also be replaced by “initiating a random access procedure to a PSCell”.

In some alternative implementations, the PDCCH is received by the UE by using a first TCI state. The UE determines the first TCI state based on configuration information from the network device. Alternatively, the UE determines that the first TCI state is a TCI state used by the UE for a last time the SCG was in an active state.

As an example, the UE may receive the PDCCH configured for scheduling the PSCell by using the first TCI state configured by the network device. Here, the network device may determine the first TCI state based on measurement results reported by the UE. The first TCI state is used to determine receiving beams and/or transmitting beams for the PDCCH on the PSCell side.

As an example, the UE may receive the PDCCH configured for scheduling the PSCell by using the first TCI state that is considered to be still valid before (i.e., a previous TCI state on the SCG side). Here, relevant information (such as the TA, the TCI state, etc.) that the UE interacted with the SCG when the SCG was previously in the active state is stored on the UE side, and when the SCG re-enters the active state, the UE may consider that the information is still valid.

In the above solution, optionally, the first timer is configured by an RRC signaling or an MAC CE or a system broadcast message configuration. As an example, configuration information of the first timer is carried in the first command or an RRC reconfiguration signaling.

Second Solution

In the embodiments of the present disclosure, after the UE receives the first command, the UE initiates the random access procedure to the SCG and starts the second timer. Alternatively, the UE initiates the random access procedure to the SCG in a case that a second condition is satisfied, and starts the second timer.

In some alternative implementations, the second condition includes that the UE determines to initiate the random access procedure to the SCG based on an indication from a network device, or that the UE determines to initiate the random access procedure to the SCG based on an evaluation of the UE.

As an example, after the UE receives the first command, in response to that the UE determines to initiate the random access procedure to the SCG according to the indication from the network device, the UE initiates the random access procedure to the SCG and starts the second timer T2.

As an example, after the UE receives the first command, in response to that the UE determines to initiate the random access procedure to the SCG according to the evaluation of the UE, the UE initiates the random access procedure to the SCG and starts the second timer T2.

As an example, after receiving the first command, the UE directly initiates the random access procedure to the SCG and starts the second timer T2.

In the embodiments of the present disclosure, in response to that the random access procedure initiated by the UE to the SCG is successful before the second timer expires, the UE stops the second timer. In response to that the second timer expires, the UE determines that the random access procedure initiated to the SCG fails, and the UE sends an SCGFailureInformation message to a MN.

In some alternative implementations, the random access procedure initiated by the UE to the SCG being successful is represented through at least one of following.

The UE receives a PDCCH scrambled by a C-RNTI of the SCG side.

The UE receives a contention resolution MAC CE.

As an example, in response to that the random access procedure initiated by the UE to the SCG is successful before the second timer expires (e.g., the PDCCH scrambled by the C-RNTI of the SCG side is received or the contention resolution MAC CE is received), the UE stops the second timer T2. In response to that the second timer expires, the UE sends an SCGFailureInformation message to the MN.

It should be noted that in the embodiments of the present disclosure, the description of “initiating a random access procedure to a SCG” may also be replaced by “initiating a random access procedure to a PSCell”.

In the above solution, optionally, the second timer is configured by an RRC signaling or an MAC CE or a system broadcast message configuration. As an example, configuration information of the second timer is carried in the first command or an RRC reconfiguration signaling.

Further, the present disclosure may further include following third solution. It should be noted that the following third solution may be implemented alone or in combination with the above first solution or second solution.

Third Solution

In the embodiments of the present disclosure, the UE performs a Beam Failure Detection (BFD) during deactivation of the SCG. The UE performs Beam Failure Recovery (BFR) detection according to a first cycle in response to that a BFD event is detected by the UE.

In some alternative implementations, the first cycle is longer than or equal to a target cycle and the first cycle may also be referred to as a long cycle. As an example, the first cycle is longer than a detection cycle of the BFD.

In the embodiments of the present disclosure, the UE performs the BFD by using a first BFD configuration parameter during the deactivation of the SCG. In response to that the BFD event is detected by the UE, the UE records the BFD event. At the same time, the UE periodically detects whether there is a beam satisfying a third condition according to the first cycle (i.e., the UE performs the BFR detection).

In some alternative implementations, in response to that the beam satisfying the third condition is detected by the UE, the UE records the beam satisfying the third condition, and continues performing the BFD by using the first BFD configuration parameter. In response to that no beam satisfying the third condition is detected by the UE, the UE continues periodically detecting whether there is the beam satisfying the third condition according to the first cycle.

In some alternative implementations, the third condition is that a signal quality of a beam is greater than or equal to a specified threshold.

In the embodiments of the present disclosure, in response to that the BFD event is detected by the UE during the deactivation of the SCG, the UE records the BFD event (which may be understood as recording beams on which the failure occurs). At the same time, the UE periodically detects whether there is a beam satisfying a third condition (which may be understood as good beams) by using the first cycle (e.g., T3). 1) If the beam exists, the UE records the BFR event (which may be understood as recording beams satisfying the third condition), and performs the BFD by using a previous BFD configuration parameter (i.e., the first BFD configuration parameter) (i.e., performing the BFD according to a previous beam detection behavior). 2) If not exist, the UE continues periodically detecting whether there is the beam satisfying the third condition (which may be understood as good beams) by using the first cycle (e.g., T3).

According to the technical solutions in the embodiments of the present disclosure, a rapid recovery of the SCG from an anomaly is realized during the SCG recovery process, thereby achieving the purpose of the rapid recovery of the SCG.

Preferred embodiments of the present disclosure have been described in detail with reference to the accompanying drawings, but the present disclosure is not limited to the specific details of the above embodiments. Within the scope of the technical conception of the present disclosure, various simple modifications can be made to the technical solution of the present disclosure, and these simple modifications all fall within the scope of protection of the present disclosure. For example, various specific technical features described in the above specific embodiments may be combined in any suitable manner without conflict. Various possible combinations are not further described in the present disclosure to avoid unnecessary repetition. For another example, various different implementations of the present disclosure can also be combined arbitrarily, which should also be considered as the content disclosed by the present disclosure as long as they do not violate the conception of the present disclosure. For another example, various embodiments described in the present disclosure and/or the technical features in various embodiments can be arbitrarily combined with the prior art without conflict, and the technical solution obtained after the combination should also fall within the scope of protection of the present disclosure.

It should also be understood that in the various method embodiments of the present disclosure, the size of the serial numbers of the above-mentioned various processes do not indicate a sequence of execution. The sequence of execution of the processes should be determined by their functions and inherent logics, and should not constitute a limitation on the implementation process of the embodiments of the present disclosure. Further, in embodiments of the present disclosure, the terms “downlink”, “uplink” and “sidelink” are used to indicate transmission directions of signals or data. The term “downlink” is used to indicate that the transmission direction of the signals or the data is a first direction from a station to a user equipment of a cell. The term “uplink” is used to indicate that the transmission direction of the signals or the data is a second direction from the user equipment of the cell to the station. The term “sidelink” is used to denote that the transmission direction of the signals or the data is a third direction from a first user equipment to a second user equipment. For example, “downlink signal” means that the transmission direction of the signal is the first direction. In addition, in the embodiments of the present disclosure, the term “and/or” refers to only an association relationship for describing associated objects and represents that three relationships may exist. Specifically, A and/or B may represent three cases: i.e., only A exists, both A and B exist, and only B exists. Furthermore, character “/” in the disclosure usually represents that previous and next associated objects form an “or” relationship.

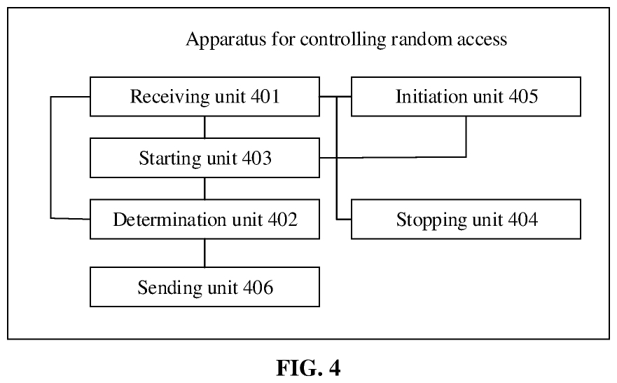

FIG. 4 is a structure diagram of an apparatus for controlling random access according to an embodiment of the present disclosure, which is applied to a UE. As shown in FIG. 4, the apparatus for controlling the random access includes a receiving unit 401 and a determination unit 402

The receiving unit 401 is configured to receive a first command, and the first command is used for activating a Secondary Cell Group (SCG).

The determination unit 402 is configured to determine whether to initiate a random access procedure to the SCG based on a first timer and/or whether the random access procedure initiated to the SCG is successful based on a second timer.

In some alternative implementations, the apparatus further includes a starting unit 403.

After the receiving unit 401 receives the first command, the starting unit 403 is configured to start the first timer; or

the starting unit 403 is configured to start the first timer in a case that a first condition is satisfied.

In some alternative implementations, the first condition includes the following operations.

The UE determines not to initiate the random access procedure to the SCG based on an indication from a network device.

Alternatively, the UE determines not to initiate the random access procedure to the SCG based on an evaluation of the UE.

In some alternative implementations, the apparatus further includes a stopping unit 404.

In response to that the receiving unit 401 receives a PDCCH configured for scheduling a PSCell during an operation of the first timer, the determination unit 402 is configured to determine not to initiate the random access procedure to the SCG and the stopping unit 404 stops the first timer.

In response to that the first timer expires, the determination unit 403 is configured to determine to initiate the random access procedure to the SCG and/or to send an SCGFailureInformation message to a MN.

In some alternative implementations, the PDCCH is received by the receiving unit 401 by using a first TCI state.

The determination unit 402 is further configured to determine the first TCI state based on configuration information from the network device, or determine that the first TCI state is a TCI state used by the UE for a last time the SCG was in an active state.

In some alternative implementations, the first timer is configured by an RRC signaling or an MAC CE or a system broadcast message configuration.

In some alternative implementations, configuration information of the first timer is carried in the first command or an RRC reconfiguration signaling.

In some alternative implementations, the apparatus further includes an initiation unit 405 and the starting unit 403.

The initiation unit 405 is configured to initiate the random access procedure to the SCG, and the starting unit 403 is configured to start the second timer.

Alternatively, the initiation unit 405 is configured to initiate the random access procedure to the SCG in a case that a second condition is satisfied, and the starting unit 403 is configured to start the second timer.

In some alternative implementations, the second condition includes the followings.

The UE determines to initiate the random access procedure to the SCG based on an indication from a network device; or

the UE determines to initiate the random access procedure to the SCG based on an evaluation of the UE.

In some alternative implementations, the apparatus further includes the stopping unit 404 and a sending unit 406.

In response to that the random access procedure initiated by the UE to the SCG is successful before the second timer expires, the stopping unit 404 is configured to stop the second timer.

In response to that the second timer expires, the determination unit 402 is configured to determine that the random access procedure initiated to the SCG fails, and the sending unit 406 is configured to send an SCGFailureInformation message to an MN.

In some alternative implementations, the random access procedure initiated by the UE to the SCG being successful is represented through at least one of following.

The UE receives a PDCCH scrambled by a C-RNTI of the SCG side.

The UE receives a contention resolution MAC CE.

In some alternative implementations, the second timer is configured by an RRC signaling or an MAC CE or a system broadcast message configuration.

In some alternative implementations, configuration information of the second timer is carried in the first command or an RRC reconfiguration signaling.

In some alternative implementations, the apparatus further includes a detection unit.

The detection unit 407 is configured to perform BFD during the deactivation of the SCG, and to perform BFR detection according to a first cycle in response to that a BFD event is detected.

In some alternative implementations, the apparatus further includes a recording unit 408.

The detection unit 407 is configured to perform the BFD by using a first BFD configuration parameter during the deactivation of the SCG, and in response to that the BFD event is detected by the UE, the recording unit 408 is configured to record the BFD event.

In some alternative implementations, the detection unit 407 is configured to periodically detect whether there is a beam satisfying a third condition according to the first cycle.

In some alternative implementations, the apparatus further includes the recording unit 408.

In response to that the beam satisfying the third condition is detected by the detection unit 407, the recording unit 408 is configured to record the beam satisfying the third condition, and the detection unit 407 is configured to continue performing the BFD by using a first BFD configuration parameter.

In response to that no beam satisfying the third condition is detected by the detection unit 407, the detection unit 407 is configured to continue periodically detecting whether there is the beam satisfying the third condition according to the first cycle.

In some alternative implementations, the third condition is that a signal quality of a beam is greater than or equal to a specified threshold.

Those skilled in the art would appreciate that the relevant description of the above apparatus for controlling the random access according to the embodiments of the present disclosure may be understood with reference to the relevant description of the method for controlling the random access according to the embodiments of the present disclosure.

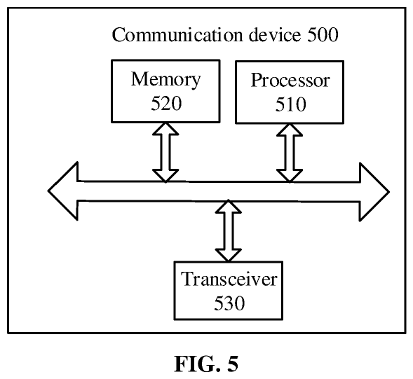

FIG. 5 is a structure diagram of a communication device 500 according to an embodiment of the present disclosure. The communications device may be a UE. The communications device 500 shown in FIG. 5 includes a processor 510, and the processor 510 is configured to invoke and run a computer program from a memory to implement the methods in the embodiments of the present disclosure.

Optionally, as shown in FIG. 5, the communications device 500 may further include a memory 520, and the processor 510 is configured to invoke and run a computer program from the memory 520 to implement the methods in the embodiments of the present disclosure.

The memory 520 may be a separate device independent of the processor 510, or may be integrated in the processor 510.

Optionally, as shown in FIG. 5, the communication device 500 may further include a transceiver 530, and the processor 510 may control the transceiver 530 to communicate with other devices. Specifically, the processor 510 may control the transceiver 530 to send information or data to other devices, or receive information or data from other devices.

The transceiver 530 may include a transmitter and a receiver. The transceiver 530 may further include an antenna, and there may be one or more antennas.

Optionally, the communication device 500 may specifically be the mobile terminal/the UE in the embodiments of the present disclosure, and the communication device 500 may implement corresponding processes implemented by the mobile terminal/the UE in various methods of the embodiments of the present disclosure, which are not elaborated here for the sake of brevity.

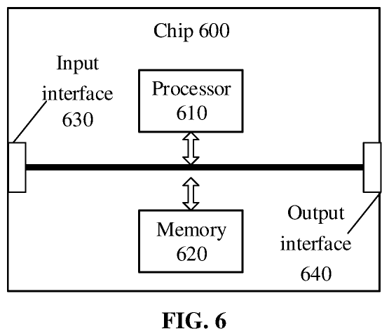

FIG. 6 is a structure diagram of a chip according to an embodiment of the present disclosure. The chip 600 shown in FIG. 6 includes a processor 610, and the processor 610 is configured to invoke and run a computer program from a memory to implement the methods in the embodiments of the present disclosure.

Optionally, as shown in FIG. 6, the chip 600 may further include a memory 620, and the processor 610 may invoke and run a computer program from the memory 620 to implement the methods in the embodiments of the present disclosure.

The memory 620 may be a separate device independent of the processor 610, or may be integrated in the processor 610.

Optionally, the chip 600 may further include an input interface 630. The processor 610 may control the input interface 630 to communicate with other devices or chips. Specifically, the processor 610 may control the input interface 630 to acquire information or data sent by other devices or chips.

Optionally, the chip 600 may further include an output interface 640. The processor 610 may control the output interface 640 to communicate with other devices or chips. Specifically, the processor 610 may control the output interface 640 to output information or data to other devices or chips.

Optionally, the chip may be applied to the mobile terminal/the UE in the embodiments of the present disclosure, and the chip may implement corresponding processes implemented by the mobile terminal/the UE in various methods of the embodiments of the present disclosure, which are not elaborated here for the sake of brevity.

It should be understood that the chip mentioned in the embodiments of the present disclosure may also be referred to as a system-level chip, a system chip, a chip system, or a system-on-chip chip, etc.

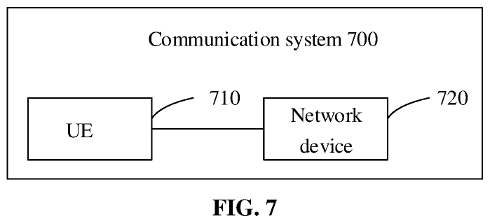

FIG. 7 is a block diagram of a communication system according to an embodiment of the present disclosure. As shown in FIG. 7, the communication system 700 includes a UE 710 and a network device 720.

The UE 710 may is configured to implement the corresponding functions implemented by the UE in the above methods, and the network device 720 is configured to implement the corresponding functions implemented by the network device in the above methods, which are not elaborated here for the sake of brevity.

It should be understood that the processor in the embodiments of the present disclosure may be an integrated circuit chip having signal processing capability. In implementation, the various operations of the above method embodiments may be accomplished by integrated logic circuit of hardware or instructions in the form of software in a processor. The processor may be a general purpose processor, a Digital Signal Processor (DSP), an Application Specific Integrated Circuit (ASIC), a Field Programmable Gate Array (FPGA) or other programmable logic devices, a discrete gate or transistor logic device, or a discrete hardware component. The methods, operations and logic block diagrams disclosed in embodiments of the present disclosure may be implemented or performed. The general purpose processor may be a microprocessor or the processor may be any conventional processor or the like. The operations of the method disclosed in combination with the embodiments of the present disclosure can be directly embodied as execution of a hardware decoding processor or combined execution of hardware and software modules in the decoding processor. The software module may be located in a Random-Access Memory (RAM), a flash memory, a Read-Only Memory (ROM), a Programmable ROM (PROM) or an Electrically Erasable EPROM (EEPROM), a register and other storage medium mature in the art. The storage medium is located in the memory, and the processor reads information in the memory and completes the operations of the above methods in combination with its hardware.

It is understood that the memory in embodiments of the present disclosure may be volatile memory or non-volatile memory or may include both volatile and non-volatile memory. The non-volatile memory may be an ROM, a PROM, an Erasable PROM (EPROM), an EEPROM, or a flash memory. The volatile memory may be an RAM which serves as an external cache. By way of illustration but not limitation, many forms of RAM are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It should be noted that the memory of the systems and methods described herein is intended to include but not be limited to these and any other suitable types of memories.

It should be understood that the memory described above is exemplary but not limiting. For example, the memory in embodiments of the present disclosure may also be a SRAM, a DRAM, a SDRAM, a DDR SDRAM, an ESDRAM, an SLDRAM, a DR RAM, etc. That is, the memory in embodiments of the present disclosure is intended to include but not be limited to these and any other suitable types of memories.

An embodiment of the present disclosure further provides a computer-readable storage medium, the computer-readable storage medium is configured to store a computer program.

Optionally, the computer-readable storage medium may be applied to the network device in the embodiments of the present disclosure, and the computer program causes a computer to execute corresponding processes implemented by the network device in various methods of the embodiments of the present disclosure, which are not elaborated here for the sake of brevity.

Optionally, the computer-readable storage medium may be applied to the mobile terminal/the UE in the embodiments of the present disclosure, and the computer program causes a computer to execute corresponding processes implemented by the mobile terminal/the UE in various methods of the embodiments of the present disclosure, which are not elaborated here for the sake of brevity.

An embodiment of the present disclosure further provides a computer program product, and the computer program product includes computer program instructions.

Optionally, the computer program product may be applied to the network device in the embodiments of the present disclosure, and the computer program instructions cause a computer to execute corresponding processes implemented by the network in various methods of the embodiments of the present disclosure, which are not elaborated here for the sake of brevity.

Optionally, the computer program product may be applied to the mobile terminal/the UE in the embodiments of the present disclosure, and the computer program instructions cause a computer to execute corresponding processes implemented by the mobile terminal/the UE in various methods of the embodiments of the present disclosure, which are not elaborated here for the sake of brevity.

An embodiment of the present disclosure further provides a computer program.

Optionally, the computer program may be applied to the network device in the embodiments of the present disclosure, and the computer program causes a computer to execute corresponding processes implemented by the network device in various methods of the embodiments of the present disclosure when the computer program is run on the computer, which are not elaborated here for the sake of brevity.

Optionally, the computer program may be applied to the mobile terminal/the UE in the embodiments of the present disclosure, and the computer program causes a computer to execute corresponding processes implemented by the mobile terminal/the UE in various methods of the embodiments of the present disclosure when the computer program is run on the computer, which are not elaborated here for the sake of brevity.

Those of ordinary skill in the art would appreciate that the various example units and algorithm steps described in connection with the embodiments in the present disclosure can be implemented in electronic hardware or a combination of computer software and electronic hardware. Whether these functions are performed in hardware or software depends on the specific application and design constraints of the technical solutions. Those of ordinary skill may use different methods for each particular application to implement the described functionality, but such implementation should not be considered outside the scope of the present disclosure.

Those skilled in the art would clearly appreciate that, for convenience and brevity of description, the specific operating processes of the above-described systems, devices and units may refer to the corresponding processes in the aforementioned method embodiments and would not be repeated herein.

In several embodiments provided in the present disclosure, it should be understood that the disclosed systems, devices and methods may be implemented in other ways. For example, the above-described embodiments of the devices are only schematic, for example, the division of the unit is only a logical function division, and in practice, there may be another division method, for example, multiple units or components may be combined or integrated into another system, or some features may be ignored or not performed. Furthermore, the coupling or direct coupling or communication connection between each other illustrated or discussed may be indirect coupling or communication connection through some interface, device or unit, and may be electrical, mechanical or other form.

The units illustrated as separate components may or may not be physically separated, and the components displayed as unit may or may not be physical units, that is, the units and the components may be located in one place, or may be distributed over multiple network units. Part or all of the units can be selected according to the actual needs to achieve the purpose of the embodiments.

In addition, various functional units in the embodiments of the present disclosure may be integrated in one processing unit, or various units may exist physically alone, or two or more units may be integrated in one unit.

The functions may be stored in a computer readable storage medium if implemented in the form of software functional units and sold or used as stand-alone products. In view of this understanding, the technical solutions of the present disclosure can be embodied in the form of a software product in essence or the part that contributes to the related art or the part of the technical solutions. The computer software product is stored in a storage medium and includes instructions that enables a computer device (which may be a personal computer, server, network device, etc.) to perform all or part of the operations of the methods described in various embodiments of the present disclosure. The aforementioned storage medium includes a U disk, a removable hard disk, a ROM, a RAM, a magnetic disk or an optical disk and other medium capable of storing program codes.

The above-mentioned is only the specific implementation of the present disclosure, but the scope of protection of the present disclosure is not limited thereto. Any variation or substitution readily conceivable by those skilled in the art within the scope of the technology disclosed in the present disclosure shall be covered by the scope of protection of the present disclosure. Therefore, the scope of protection of the present disclosure should be subject to the scope of protection of the claims.

What is claimed is:

1. A method for controlling random access, comprising:
receiving, by a User Equipment (UE), a first command, wherein the first command is used for activating a Secondary Cell Group (SCG); and
determining, by the UE, at least one of whether to initiate a random access procedure to the SCG based on a first timer or whether the random access procedure initiated to the SCG is successful based on a second timer.

2. The method of claim 1, wherein determining, by the UE, whether to initiate the random access procedure to the SCG based on the first timer comprises:
in response to that a Physical Downlink Control Channel (PDCCH) configured for scheduling a Primary Secondary Cell (PSCell) is received by the UE during an operation of the first timer, determining, by the UE, not to initiate the random access procedure to the SCG and stopping the first timer; and
in response to that the first timer expires, determining, by the UE, to perform at least one of initiating the random access procedure to the SCG or sending an SCGFailureInformation message to a Master Node (MN).

3. The method of claim 2, wherein the PDCCH is received by the UE by using a first Transmission Configuration Indication (TCI) state, and the method further comprises:
determining, by the UE, the first TCI state based on configuration information from the network device; or
determining, by the UE, that the first TCI state is a TCI state used by the UE for a last time the SCG was in an active state.

4. The method of claim 1, wherein the first timer is configured by a Radio Resource Control (RRC) signaling or a Media Access Control (MAC) Control Element (CE) or a system broadcast message configuration.

5. The method of claim 1, wherein configuration information of the first timer is carried in the first command or a Radio Resource Control (RRC) reconfiguration signaling.

6. The method of claim 1, wherein after receiving, by the UE, the first command, the method further comprises:
initiating, by the UE, the random access procedure to the SCG and starting the second timer; or
initiating, by the UE, the random access procedure to the SCG in a case that a second condition is satisfied, and starting the second timer.

7. The method of claim 6, wherein the second condition comprises:
determining, by the UE, to initiate the random access procedure to the SCG based on an indication from a network device; or
determining, by the UE, to initiate the random access procedure to the SCG based on an evaluation of the UE.

8. The method of claim 1, wherein the method further comprises:
performing, by the UE, Beam Failure Detection (BFD) during deactivation of the SCG; and
performing, by the UE, Beam Failure Recovery (BFR) detection according to a first cycle in response to that a BFD event is detected by the UE.

9. The method of claim 8, wherein performing, by the UE, the BFD during the deactivation of the SCG comprises:
performing, by the UE, the BFD by using a first BFD configuration parameter during the deactivation of the SCG, wherein in response to that the BFD event is detected by the UE, the UE records the BFD event.

10. The method of claim 8, wherein performing, by the UE, the BFR according to the first cycle comprises:
periodically detecting, by the UE, whether there is a beam satisfying a third condition according to the first cycle.

11. A User Equipment (UE), comprising:
a transceiver, configured to receive a first command, wherein the first command is used for activating a Secondary Cell Group (SCG); and
a processor, configured to determine at least one of whether to initiate a random access procedure to the SCG based on a first timer or whether the random access procedure initiated to the SCG is successful based on a second timer.

12. The UE of claim 11, wherein
in response to that a Physical Downlink Control Channel (PDCCH) configured for scheduling a Primary Secondary Cell (PSCell) is received by the transceiver during an operation of the first timer, the processor is further configured to determine not to initiate the random access procedure to the SCG and the stopping unit stops the first timer, and
in response to that the first timer expires, the processor is further configured to determine to perform at least one of initiating the random access procedure to the SCG or sending an SCGFailureInformation message to a Master Node (MN).

13. The UE of claim 12, wherein the PDCCH is received by the transceiver by using a first Transmission Configuration Indication (TCI) state,
wherein the processor is further configured to determine the first TCI state based on configuration information from the network device; or the processor is further configured to determine that the first TCI state is a TCI state used by the UE for a last time the SCG was in an active state.

14. The UE of claim 11, wherein the first timer is configured by a Radio Resource Control (RRC) signaling or a Media Access Control (MAC) Control Element (CE) or a system broadcast message configuration.

15. The UE of claim 11, wherein configuration information of the first timer is carried in the first command or a Radio Resource Control (RRC) reconfiguration signaling.

16. The UE of claim 11, wherein the processor is further configured to:
initiate the random access procedure to the SCG, and start the second timer; or
initiate the random access procedure to the SCG in a case that a second condition is satisfied, and start the second timer.

17. The UE of claim 16, wherein the second condition comprises:
determining, by the UE, to initiate the random access procedure to the SCG based on an indication from a network device; or
determining, by the UE, to initiate the random access procedure to the SCG based on an evaluation of the UE.

18. The UE of claim 11, wherein the processor is further configured to:
perform Beam Failure Detection (BFD) during the deactivation of the SCG; and perform Beam Failure Recovery (BFR) detection according to a first cycle in response to that a BFD event is detected.

19. The UE of claim 18, wherein the processor is further configured to:
perform the BFD by using a first BFD configuration parameter during the deactivation of the SCG, wherein in response to that the BFD event is detected by the UE, the processor is further configured to record the BFD event.

20. The UE of claim 18, wherein the processor is configured to periodically detect whether there is a beam satisfying a third condition according to the first cycle.
